(19) United States
(12) Patent Application Publication
(10) Pub. No.: US 2021/0396677 A1
(43) Pub. Date: Dec. 23, 2021

(54) DETECTION SUBSTRATE, RAMAN SPECTRUM DETECTION SYSTEM, AND RAMAN SPECTRUM DETECTION METHOD

(71) Applicant: Tamkang University, New Taipei City (TW)

(72) Inventors: Shih-Chieh Hsu, New Taipei City (TW); Ching-Hsiang Chen, New Taipei City (TW); Cheng-Ju Sung, New Taipei City (TW); Szu-Han Chao, New Taipei City (TW)

(73) Assignee: Tamkang University, New Taipei City (TW)

(21) Appl. No.: 17/196,270

(22) Filed: Mar. 9, 2021

(30) Foreign Application Priority Data
Jun. 22, 2020 (TW) 109121224

(51) Int. Cl. G01N 21/65; G01N 21/75; G01J 3/44

(52) U.S. Cl. CPC G01N 21/65; G01J 3/44; G01N 21/75

(57) ABSTRACT

A detection substrate includes a substrate, a wetting layer, a barrier layer, a reaction layer, a counter electrode layer, a reference electrode layer, an insulating frame, and a plurality of wirings. The substrate includes a counter electrode, a working electrode, and a reference electrode. The reaction layer is located on the barrier layer. A surface of the reaction layer has a naturally micro-etched nano pattern. The counter electrode layer has an accommodating area which accommodates the reaction layer, and the naturally micro-etched nano pattern is exposed from the accommodating area. The insulating frame is located on a measurement area. The detection substrate has electrodes. During use, a predetermined reaction potential is applied to the detection substrate by an electrochemical device, and a Raman spectroscopy analysis is performed to obtain a strengthened Raman spectroscopy signal. A Raman spectrum detection system and a Raman spectrum detection method are also provided.

### CROSS-REFERENCE TO RELATED APPLICATION

This non-provisional application claims priority under 35 U.S.C. § 119(a) to Patent Application No. 109121224 filed in Taiwan, R.O.C. on Jun. 22, 2020, the entire contents of which are hereby incorporated by reference.

### BACKGROUND

### Technical Field

Disclosed is a detection substrate, especially a detection substrate that can be used in combination with an electrochemical device and a Raman spectrum analyzer. The present invention also provides a Raman spectrum detection system with the detection substrate and a Raman spectrum detection method.

### Related Art

Each time the conventional surface-enhanced Raman spectroscopy (SERS) measurement technology is used for biological detection, necessary improvement is performed on a detection substrate to match a measurement system. Therefore, a structure of a substrate needs to be constantly changed for different measurement systems, which consumes a lot of production time and production costs.

For example, concentration of glucose in blood sugar is to be measured. Conventionally, glucose molecules are less incapable of being adsorbed on a metal surface. Therefore, the prior art provides a method of constructing a self-assembled monolayer (SAM) to strengthen an adsorption capability or a reaction capability of the glucose molecules, to enhance a Raman spectrum signal.

However, when different target objects are to be detected, a substrate for constructing the SAM layer needs to be replaced (a detection substrate that can correspondingly adsorb target molecules is required). As a result, costs for improving the substrate and complexity of a structure are further increased. If the detection substrate with the self-assembled monomolecular film is still used on a to-be-detected object other than glucose, an analysis result of contents in the to-be-detected object is affected, and a service life of the detection substrate is also significantly reduced.

### SUMMARY

In view of this, the present invention provides a detection substrate in an embodiment. The detection substrate includes a substrate, a wetting layer, a barrier layer, a reaction layer, a counter electrode layer, a reference electrode layer, an insulating frame, and a plurality of wirings.

A measurement area, a wiring area, and an electrode area are defined on the substrate. The substrate includes a counter electrode, a working electrode, and a reference electrode that are located on the electrode area.

The wetting layer is located on the measurement area. The barrier layer is located on the wetting layer. The reaction layer is located on the barrier layer, where a surface of the reaction layer has a naturally micro-etched nano pattern. The counter electrode layer has an accommodating area that can accommodate the reaction layer, and the naturally micro-etched nano pattern of the reaction layer is exposed from the accommodating area. The reference electrode layer is located on the measurement area and on a side of the counter electrode layer. The insulating frame is located on the measurement area, and the insulating frame surrounds the wetting layer, the barrier layer, the reaction layer, the counter electrode layer, and the reference electrode layer.

The wirings are located on the wiring area, and the working electrode is electrically connected to the reaction layer, the counter electrode is electrically connected to the counter electrode layer, and the reference electrode is electrically connected to the reference electrode layer via the wirings.

According to the above detection substrate, in an embodiment, the reaction layer includes at least one of gold and silver.

According to the above detection substrate, in an embodiment, a thickness of the reaction layer ranges from 1 nm to 100 μm.

According to the above detection substrate, in an embodiment, the naturally micro-etched nano pattern includes a plurality of nano-scaled bumps and a plurality of nano-scaled recesses, where the bumps and the recesses are randomly distributed.

The present invention further provides a Raman spectrum detection system. The detection system includes a detection substrate, an electrochemical device, and a Raman spectrum analyzer.

The electrochemical device is configured to apply a reaction potential to the detection substrate.

The Raman spectrum analyzer includes a laser source, a light sensor, and an analyzer. The laser source is configured to provide a laser that is projected on the detection substrate. The light sensor is configured to receive light scattered after the laser is projected on the detection substrate, to generate a light signal. The analyzer is configured to receive and analyze the light signal according to a predetermined reaction time, to output spectrum information.

The present invention further provides a Raman spectrum detection method in an embodiment. The Raman spectrum detection method includes the following steps:

disposing a to-be-detected object on a detection substrate, where the detection substrate includes a working electrode, a counter electrode, and a reference electrode, a reaction layer, a counter electrode layer, a reference electrode layer, and a plurality of wirings, where the wirings electrically connect the working electrode to the reaction layer, electrically connect the counter electrode to the counter electrode layer, and electrically connect the reference electrode to the reference electrode layer, respectively, a surface of the reaction layer has a naturally micro-etched nano pattern, and the to-be-detected object is electrically connected to the working electrode, the counter electrode, and the reference electrode by contacting the reaction layer, the counter electrode layer, and the reference electrode layer;

electrically connecting an electrochemical device to the detection substrate, and applying a predetermined reaction potential to the detection substrate; and

detecting the to-be-detected object through a Raman spectrum analyzer, where the Raman spectrum analyzer includes a laser source, a light sensor, and an analyzer, where the laser source projects a laser on the to-be-detected object, the light sensor receives light scattered after the laser is projected on the to-be-detected object, to generate a light signal, and the analyzer receives and analyzes the light signal according to a predetermined reaction time, to output spectrum information about the to-be-detected object.

In an embodiment, the above Raman spectrum detection method further includes a step of obtaining the predetermined reaction potential and the predetermined reaction time. The step includes: performing, through voltammetry, an electrochemical reaction on a detection substrate for testing purposes that supports a target object, and obtaining the predetermined reaction potential and the predetermined reaction time according to a potential and a time for oxidation or reduction of the target object.

In an embodiment, the above Raman spectrum detection method further includes: performing an oxidation reduction cycle on the detection substrate through the electrochemical device and an electrolyte, so that the surface of the reaction layer forms the naturally micro-etched nano pattern.

According to the above Raman spectrum detection method, in an embodiment, the naturally micro-etched nano pattern includes a plurality of nano-scaled bumps and a plurality of nano-scaled recesses, where the bumps and the recesses are randomly distributed.

The detection substrate provided in an embodiment of the present invention has the following advantages: the detection substrate has electrodes and is used in combination with a Raman spectrum analyzer, to facilitate simultaneous adsorption reaction and measurement of molecules of a target object (for example, glucose) in a to-be-detected object (for example, blood or urine), thus achieving a measurement capability (below 1 ppb) of ultra-high resolution. In addition, the detection substrate may be manufactured in a large quantity for use, and does not need to be tailored for specific target molecules, so that a large amount of time costs and manufacturing costs can be reduced. The detection substrate of the present invention is not limited to types of to-be-detected objects. The detection substrate and the detection system of the present invention can be used for most to-be-detected objects such as biomedical sensing objects, pesticide to-be-detected objects, bacteria, virus particles, and plastic particles, and have excellent detection effects.

### BRIEF DESCRIPTION OF THE DRAWINGS

FIG. 1 is a top view of a detection substrate according to an embodiment of the present invention.

FIG. 2 is a schematic diagram of an exterior of a detection substrate according to an embodiment of the present invention.

FIG. 3 is an exploded view of a detection substrate according to an embodiment of the present invention.

FIG. 4 is a schematic diagram of a Raman spectrum detection system according to an embodiment of the present invention.

FIG. 5 is a schematic flowchart of a Raman spectrum detection method according to an embodiment of the present invention.

FIG. 6 is a topography of a surface of a reaction layer of a detection substrate according to an embodiment of the present invention observed under an atomic force microscope.

FIG. 7 is a schematic flowchart of an embodiment of a Raman spectrum detection method according to the present invention.

FIG. 8 is a comparison diagram of detection results of an embodiment of a Raman spectrum detection method according to the present invention.

### DETAILED DESCRIPTION

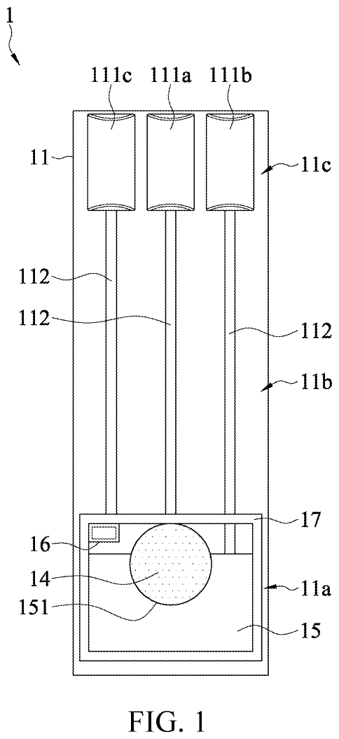

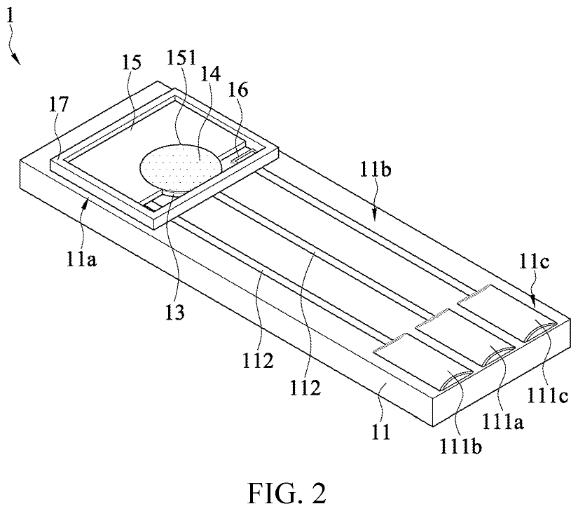

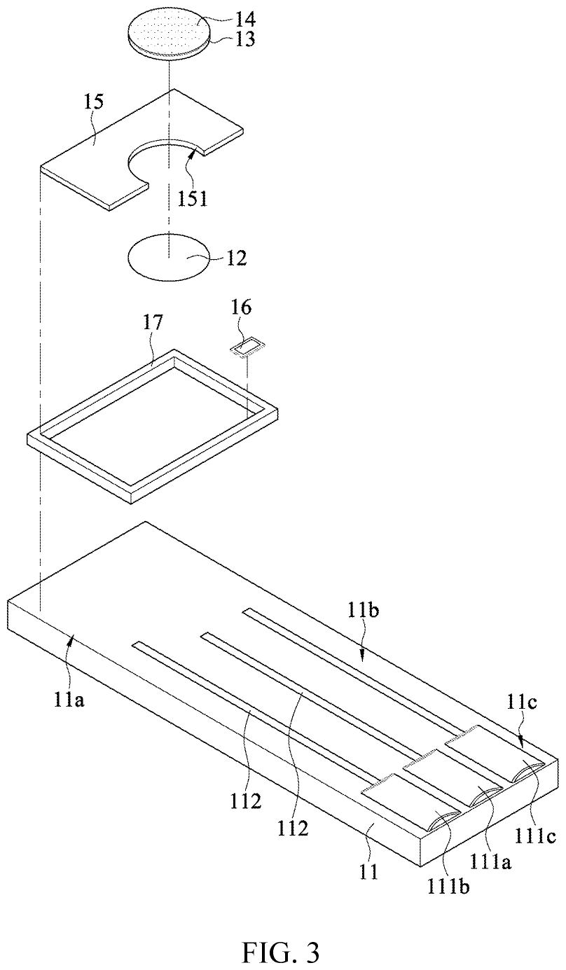

FIG. 1 to FIG. 3 are respectively a top view, a schematic diagram of an exterior, and an exploded view of a detection substrate 1 according to an embodiment of the present invention. The detection substrate 1 includes a substrate 11, a wetting layer 12, a barrier layer 13, a reaction layer 14, a counter electrode layer 15, and a reference electrode layer 16.

A measurement area 11a, a wiring area 11b, and an electrode area 11c are defined on the substrate 11. The substrate 11 includes a counter electrode (CE) 111b, a working electrode (WE) 111a, and a reference electrode (RE) 111c which are located on the electrode area 11c. In the embodiment shown in FIG. 1, the counter electrode 111b, the working electrode 111a, and the reference electrode 111c are integrated on the electrode area 11c. However, the present invention is not limited thereto. In some embodiments, there are a plurality of electrode areas 11c on the substrate 11, in which the counter electrode 111b, the working electrode 111a, and the reference electrode 111c are respectively provided. In an embodiment, the substrate 11 is made of epoxy resin, and has an insulating layer on the wiring area 11b.

The wetting layer 12 is located on the measurement area 11a. In an embodiment, the wetting layer is made of copper, titanium, or chromium.

The barrier layer 13 is located on the wetting layer 12. In an embodiment, the barrier layer is a nickel layer. The reaction layer 14 is located on the barrier layer 13, and a surface of the reaction layer 14 has a naturally micro-etched nano pattern. The reaction layer 14 includes at least one of gold and silver. In an embodiment, the reaction layer 14 further includes silicon oxide, titanium oxide, or other compounds. Preferably, the reaction layer 14 is a pure gold layer. A thickness of the reaction layer 14 is between 1 nm and 100 μm.

In an embodiment, the reaction layer 14 is a gold layer, and the barrier layer 13 is a nickel layer. Both may be disposed on the wetting layer 12 through electroless nickel immersion gold.

The naturally micro-etched nano pattern is micro-etched, and the surface of the reaction layer 14 presents a plurality of nano-scaled bumps and a plurality of nano-scaled recesses. The bumps and the recesses are randomly distributed. For details, refer to the following description.

The counter electrode layer 15 has an accommodating area 151 that can accommodate the reaction layer 14. The naturally micro-etched nano pattern of the reaction layer 14 is exposed from the accommodating area 151. In an embodiment, the counter electrode layer 15 is made of carbon. In an embodiment, the counter electrode layer 15 is made of platinum.

The reference electrode layer 16 is located on the measurement area Ila and on a side of the counter electrode layer 15. In an embodiment, the reference electrode layer 16 consists of silver and silver chloride. The insulating frame 17 is located on the measurement area 11a, and the insulating frame 17 surrounds the wetting layer 12, the barrier layer 13, the reaction layer 14, the counter electrode layer 15, and the reference electrode layer 16, to define a measurement boundary. In other words, when the detection substrate 1 supports the to-be-detected object, the to-be-detected object is located within the measurement boundary and is electrically connected to the counter electrode 111b, the working electrode 111a, and the reference electrode 111c by contacting the reaction layer 14, the counter electrode layer 15, and the reference electrode layer 16. In an embodiment, the insulating frame 17 is made of silicon.

The wirings 112 are located on the wiring area 11b. The working electrode 111a is electrically connected to the reaction layer 14, the counter electrode 111b is electrically connected to the counter electrode layer 15, and the reference electrode 111c is electrically connected to the reference electrode layer 16 via the wirings 112.

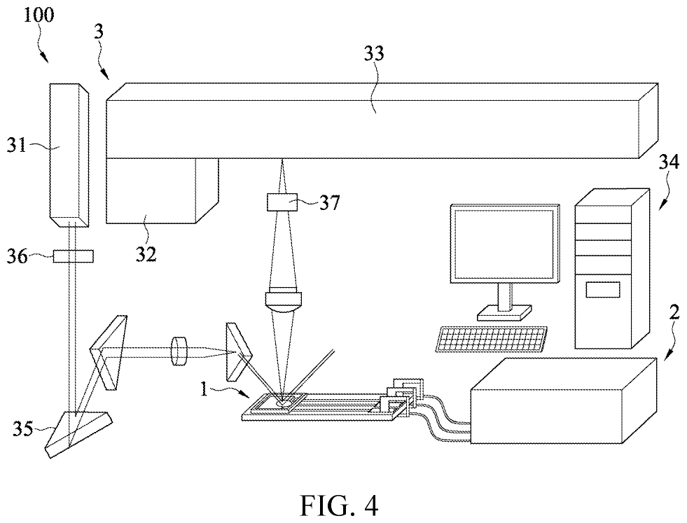

FIG. 4 is a schematic diagram of a Raman spectrum detection system 100 according to an embodiment of the present invention. The Raman spectrum detection system 100 may be configured to detect spectrum information about the to-be-detected object. The to-be-detected object is, for example, blood, urine, plastic particles, contaminated seawater, or the like. For example, the to-be-detected object is urine. In this case, substances (a target object, for example, glucose) contained in the urine may be detected. The detection system 100 includes a detection substrate 1, an electrochemical device 2, and a Raman spectrum analyzer 3.

The detection substrate 1 is as described above. The reaction layer 14 has a surface with a naturally micro-etched nano pattern. The naturally micro-etched nano pattern has a plurality of nano-scaled bumps and recesses that are randomly distributed, which indicates that the surface of the reaction layer 14 is rough to a specific extent.

In an embodiment, the to-be-detected object is disposed in the insulating frame 17 in such a way that the to-be-detected object is in contact with the reaction layer 14, the counter electrode layer 15, and the reference electrode layer 16, so as to be electrically connected to the counter electrode 111b, the working electrode 111a, and the reference electrode 111c. The electrochemical device 2 is electrically connected to the working electrode 111a, the reference electrode 111c, and the counter electrode 111b, and applies a predetermined reaction potential to the detection substrate 1. The reaction potential may be an oxidation potential or a reduction potential. In this embodiment, the reaction potential is the oxidation potential. In this way, oxidation and reduction reactions are respectively performed on the reaction layer 14 and the counter electrode layer 15.

The Raman spectrum analyzer 3 includes a laser source 31, a light sensor 32, and an analyzer 33. The laser source 31 projects a laser on the to-be-detected object. When the laser interacts with a molecule of the target object of the to-be-detected object, a photon collides with the molecule of the target object to exchange energy. The photon transfers a part of energy to the molecule of the target object or obtains a part of energy from the molecule of the target object, thereby changing a frequency of the light so that the light is scattered out. In an embodiment, the target object is glucose, and a wavelength of the laser source 31 may be 325 nm, 405 nm, 455 nm, 532 nm, 633 nm, or 785 nm. It may be understood that the wavelength of the laser source 31 needs to be adjusted if the target object is of other types other than glucose. A value of the wavelength of the laser source 31 is not limited in the present invention.

The light sensor 32 receives light scattered after the laser irradiates on the to-be-detected object, to generate a light signal (a SERS signal). The analyzer 33 receives and analyzes the light signal according to a predetermined reaction time to obtain and output spectrum information (for example, the spectrum information is outputted and displayed on a display). It can be learned whether a target object exists in the to-be-detected object according to the spectrum information, which is qualitative analysis. For example, it can be learned whether glucose exists in urine, and then a concentration of the target object is obtained according to other analysis steps.

In this embodiment, the Raman spectrum analyzer 3 further includes a plurality of optical lenses 35, an optical filter 36, and a filter 37. The optical filter 36 eliminates interference light and noise. The filter 37 can limit the Raman wavelength to facilitate analysis. A user may perform the operation of the Raman spectrum analyzer 3 by operating a computer device 34, or may perform the operation of the electrochemical device 2 by operating the computer device 34.

It should be particularly noted that when the Raman spectrum analyzer 3 projects the laser for analysis, an electrosorption reaction is performed on the detection substrate 1. Since the detection substrate 1 has electrodes, the detection substrate 1 is electrically connected to the electrochemical device 2 to perform the above oxidation and reduction reactions (that is, the electrosorption reaction). Since the surface of the reaction layer 14 has the above naturally micro-etched nano pattern which has a plurality of nano-scaled bumps and recesses, the SERS signal may be improved for the Raman spectrum analyzer 3, so that a detection result is more accurate.

In addition, it may be understood that, in an embodiment, the detection system 100 can still be used (or for testing purposes) when the detection substrate 1 does not support a to-be-detected object. The laser of the laser source 31 is projected on the surface of the reaction layer 14 of the detection substrate 1, and the light sensor 32 receives light scattered after the laser is projected on the detection substrate 1, to generate a light signal. The analyzer 33 may still receive and analyze the light signal according to the predetermined reaction time, to output spectrum information.

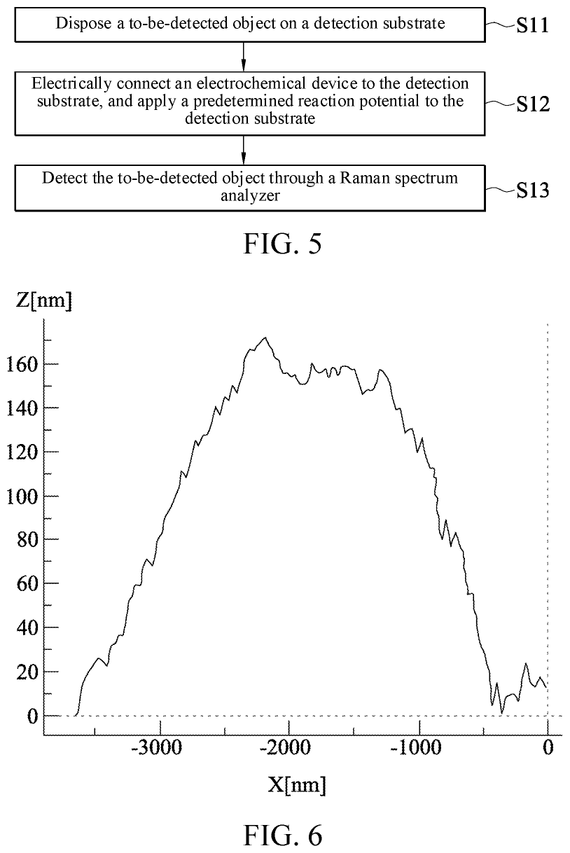

FIG. 5 is a schematic flowchart of a Raman spectrum detection method according to an embodiment of the present invention. The Raman spectrum detection method includes the following steps.

S11: Dispose a to-be-detected object on a detection substrate 1. The to-be-detected object is electrically connected to a counter electrode 111b, a working electrode 111a, and a reference electrode 111c by contacting a reaction layer 14, a counter electrode layer 15, and a reference electrode layer 16. The detection substrate 1 has a structure shown in FIG. 1 to FIG. 3, and details are not repeated herein again.

S12: Electrically connect an electrochemical device 2 (which is electrically connected to the reference electrode 111c, the counter electrode 111b, and the working electrode 111a) to the detection substrate 1, and apply a predetermined reaction potential to the detection substrate 1. The reaction potential may be an oxidation potential or a reduction potential. In this embodiment, the electrochemical device 2 applies the predetermined reaction potential to perform an oxidation reaction on the reaction layer 14 and a reduction reaction on the counter electrode layer 15. In this step, in order for the above electrosorption reaction to occur, molecules of a target object of the to-be-detected object are strengthened so that they are adsorbed on a surface of the reaction layer 14.

S13: Detect the to-be-detected object through a Raman spectrum analyzer 3. For details of the Raman spectrum analyzer 3, refer to FIG. 4 and the above description, which are not described herein again. An analyzer 33 of the Raman spectrum analyzer 3 receives and analyzes a light signal according to a predetermined reaction time, and outputs spectrum information. The predetermined reaction potential and the predetermined reaction time may be a reaction potential and a reaction time estimated or preset by a user. In some embodiments, a predetermined reaction potential and a predetermined reaction time that are most suitable for detection may be obtained according to other steps. For details, refer to the following description.

FIG. 6 is a topography of a surface of a reaction layer 14 of a detection substrate 1 according to an embodiment of the present invention observed under an atomic force microscope. It should be noted that, in some embodiments, an oxidation reduction cycle is performed on the detection substrate 1 through an electrochemical device 2 and an electrolyte, so that the surface of the reaction layer 14 forms a naturally micro-etched nano pattern. The naturally micro-etched nano pattern has a plurality of nano-scaled bumps and recesses. The bumps and the recesses are randomly distributed as described above.

The surface of the reaction layer 14 is made into the naturally micro-etched nano pattern. In some other embodiments, sulfuric acid of different concentrations may be used as the electrolyte. Parameters of the oxidation-reduction cycle are as follows: time: 5 s, initial potential: −600 mV, oxidation potential: +1600 mV, scanning speed: 10 mV/s, number of cycles: 0, 3, 6, and 9, and concentration of the electrolyte: sulfuric acid of 0.5 M, 0.25 M, and 0.1 M. However, the above parameters are merely examples, and a way of performing the oxidation-reduction cycle by the electrochemical device is not limited by these parameters in the present invention. In the surface topography observed under the atomic force microscope (AFM) in the embodiment shown in FIG. 6 that is obtained after an oxidization reduction reaction performed under conditions that the reaction layer 14 is a gold layer, the time is 5s, the initial potential is −600 mV, the oxidation potential is +1600 mV, the scanning speed is 10 mV/s, the number of cycles is 3, and the electrolyte is 0.5 M sulfuric acid, an average roughness within an observation range is 105 nm.

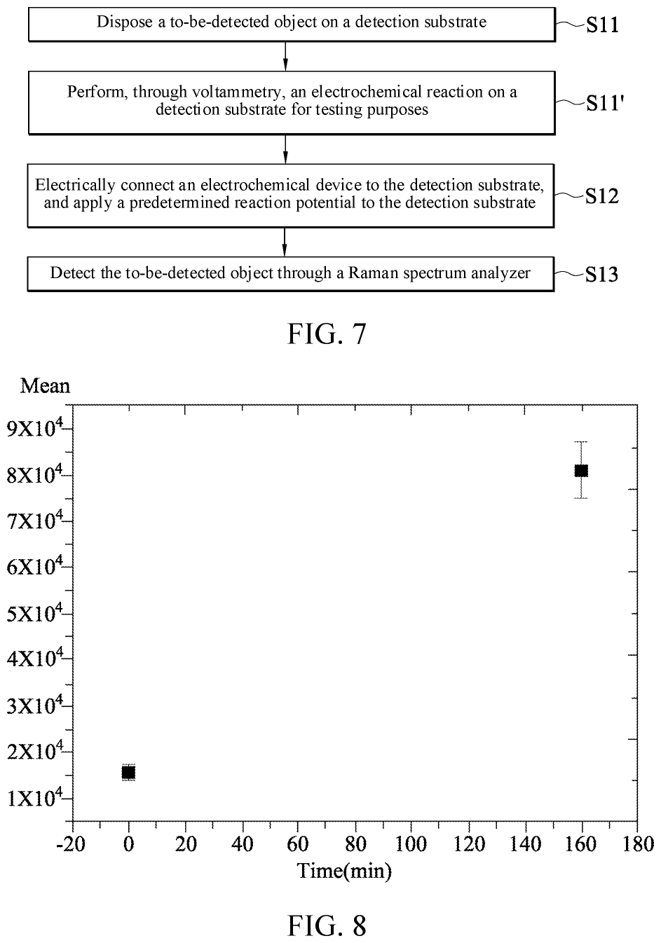

FIG. 7 is a schematic flowchart of an embodiment of a Raman spectrum detection method according to the present invention. In this embodiment, the method further includes a step S11′ of obtaining the predetermined reaction potential and the predetermined reaction time: performing, through voltammetry, an electrochemical reaction on a detection substrate 1 for testing purposes, where the detection substrate 1 for testing purposes supports a target object, and obtaining the predetermined reaction potential and the predetermined reaction time according to a potential and a time for oxidation or reduction of the target object.

In an embodiment, if the target object is glucose, an oxidation potential and an oxidation time for glucose are found in this step. The voltammetry is, for example, to apply a potential function through cyclic voltammetry (CV) or linear sweep voltammetry (LSV), and analyze a corresponding generated current, to obtain information about the electrochemical reaction between the target object and the electrode, thereby obtaining the predetermined reaction potential and the predetermined reaction time. In some embodiments, the reduction potential and the reduction time for the target object are obtained as the above predetermined reaction potential and predetermined reaction time.

In an embodiment, when the target object is glucose, the predetermined reaction potential is a predetermined oxidation potential ranging from 80 mV to 130 mV. Preferably, the predetermined oxidation potential is 100 mV. The predetermined reaction time ranges from 0 min to 210 min. Preferably, the preset reaction time is 160 min. In this way, in step S12, if the to-be-detected object is blood or urine, spectrum information about glucose in the to-be-detected object may be obtained according to values or ranges of the predetermined reaction potential (that is, the predetermined oxidation potential) and the predetermined reaction time.

FIG. 8 is a comparison diagram of detection results of an embodiment of a Raman spectrum detection method according to the present invention. In FIG. 8, a value at an upper right corner is a result detected through the Raman spectrum detection method of the present invention, that is, an electrosorption reaction is performed while Raman spectrum analysis is being performed. A value at a lower left corner indicates that only the Raman spectrum analysis is performed but no electrosorption reaction is performed. It can be clearly learned from FIG. 8 that intensity of a Raman signal is obviously enhanced in the detection result obtained through the Raman spectrum detection method of the present invention, which indicates that for microscale target objects, excellent measurement accuracy can be obtained through the detection according to the Raman spectrum detection method of the present invention.

The detection substrate provided in an embodiment of the present invention has the following advantages: the detection substrate has electrodes and is used in combination with a Raman spectrum analyzer, to facilitate simultaneous adsorption reaction and measurement of molecules of a target object (for example, glucose) in a to-be-detected object (for example, blood or urine), thus achieving a measurement capability (below 1 ppb) of ultra-high resolution. In addition, the detection substrate may be manufactured in a large quantity for use, and does not need to be tailored for specific target molecules, so that a large amount of time costs and manufacturing costs can be reduced. The detection substrate of the present invention is not limited to types of to-be-detected objects. The detection substrate and the detection system of the present invention can be used for most to-be-detected objects such as biomedical sensing objects, pesticide to-be-detected objects, bacteria, virus particles, and plastic particles, and have excellent detection effects.

What is claimed is:

1. A detection substrate, comprising:
a substrate defining a measurement area, a wiring area, and an electrode area, wherein the substrate comprises a counter electrode, a working electrode, and a reference electrode that are located on the electrode area;
a wetting layer located on the measurement area;
a barrier layer located on the wetting layer;
a reaction layer located on the barrier layer, wherein a surface of the reaction layer has a naturally micro-etched nano pattern;
a counter electrode layer having an accommodating area, wherein the accommodating area accommodates the reaction layer, and the naturally micro-etched nano pattern of the reaction layer is exposed from the accommodating area;
a reference electrode layer located on the measurement area and on a side of the counter electrode layer;
an insulating frame located on the measurement area, wherein the insulating frame surrounds the wetting layer, the barrier layer, the reaction layer, the counter electrode layer, and the reference electrode layer; and
a plurality of wirings located on the wiring area, wherein the working electrode is electrically connected to the reaction layer, the counter electrode is electrically connected to the counter electrode layer, and the reference electrode is electrically connected to the reference electrode layer via the wirings.

2. The detection substrate according to claim 1, wherein the reaction layer comprises at least one of gold and silver.

3. The detection substrate according to claim 1, wherein a thickness of the reaction layer ranges from 1 nm to 100 μm.

4. The detection substrate according to claim 1, wherein the naturally micro-etched nano pattern comprises a plurality of nano-scaled bumps and a plurality of nano-scaled recesses, wherein the bumps and the recesses are randomly distributed.

5. A Raman spectrum detection system, comprising:
the detection substrate according to claim 1;
an electrochemical device configured to apply a predetermined reaction potential to the detection substrate; and
a Raman spectrum analyzer comprising:
a laser source configured to provide a laser that is projected on the surface of the reaction layer of the detection substrate;
a light sensor configured to receive light scattered after the laser is projected on the detection substrate to generate a light signal; and
an analyzer configured to receive and analyze the light signal according to a predetermined reaction time to output spectrum information.

6. The Raman spectrum detection system according to claim 5, wherein the reaction layer comprises at least one of gold and silver.

7. The Raman spectrum detection system according to claim 5, wherein a thickness of the reaction layer ranges from 1 nm to 100 μm.

8. The Raman spectrum detection system according to claim 5, wherein the naturally micro-etched nano pattern comprises a plurality of nano-scaled bumps and a plurality of nano-scaled recesses, wherein the bumps and the recesses are randomly distributed.

9. A Raman spectrum detection method, comprising:
disposing a to-be-detected object on a detection substrate, wherein the detection substrate comprises a working electrode, a counter electrode and a reference electrode, a reaction layer, a counter electrode layer, a reference electrode layer, and a plurality of wirings, wherein the wirings electrically connect the working electrode to the reaction layer, electrically connect the counter electrode to the counter electrode layer, and electrically connect the reference electrode to the reference electrode layer, respectively, a surface of the reaction layer has a naturally micro-etched nano pattern, and the to-be-detected object is electrically connected to the working electrode, the counter electrode, and the reference electrode by contacting the reaction layer, the counter electrode layer, and the reference electrode layer;
electrically connecting an electrochemical device to the detection substrate, and applying a predetermined reaction potential to the detection substrate; and
detecting the to-be-detected object through a Raman spectrum analyzer, wherein the Raman spectrum analyzer comprises a laser source, a light sensor, and an analyzer, wherein the laser source projects a laser on the to-be-detected object, the light sensor receives light scattered after the laser is projected on the to-be-detected object to generate a light signal, and the analyzer receives and analyzes the light signal according to a predetermined reaction time to output spectrum information about the to-be-detected object.

10. The Raman spectrum detection method according to claim 9, further comprising a step of obtaining the predetermined reaction potential and the predetermined reaction time, the step comprising:
performing, through voltammetry, an electrochemical reaction on a detection substrate for testing purposes that supports a target object, and obtaining the predetermined reaction potential and the predetermined reaction time according to a potential and a time for oxidation or reduction of the target object.

11. The Raman spectrum detection method according to claim 9, further comprising performing an oxidation reduction cycle on the detection substrate through the electrochemical device and an electrolyte, so that the surface of the reaction layer forms the naturally micro-etched nano pattern.

12. The Raman spectrum detection method according to claim 9, wherein the naturally micro-etched nano pattern comprises a plurality of nano-scaled bumps and a plurality of nano-scaled recesses, wherein the bumps and the recesses are randomly distributed.
